(19) United States
(12) Patent Application Publication
(10) Pub. No.: US 2007/0151981 A1
(43) Pub. Date: Jul. 5, 2007

(54) FIREWOOD DISPENSER

(75) Inventors: Leonard J. Halsey SR., Plattville, CO (US); Charlie Walker, Brighton, CO (US)

Correspondence Address: SWANSON & BRATSCHUN L.L.C., 1745 SHEA CENTER DRIVE, SUITE 330, HIGHLANDS RANCH, CO, 80129, US

(73) Assignee: Leonard J. Halsey SR.

(21) Appl. No.: 11/535,386

(22) Filed: Sep. 26, 2006

Related U.S. Application Data
(60) Provisional application No. 60/596,481, filed on Sep. 27, 2005.

(51) Int. Cl. G07F 11/00

(52) U.S. Cl. 221/82

(57) ABSTRACT

A firewood dispenser, which may function as a firewood vending machine, is disclosed. The firewood dispenser is capable of permitting a user to purchase a desired quantity of firewood from an inventory of firewood stored within the firewood dispenser. The user may purchase firewood from the firewood dispenser by entering the desired quantity of firewood and submitting the appropriate amount of payment into the firewood dispenser. The firewood dispenser then dispenses the desired quantity of firewood to the user. The inventory of firewood contained within the firewood dispenser may be restocked by the firewood dispenser's owner or the owner's agent on a periodic and/or on an as needed basis.

### RELATED APPLICATION

This application claims priority from U.S. Provisional Patent Application Ser. No. 60/596,481, filed Sep. 27, 2005, entitled “Firewood Dispenser” which are incorporated herein by reference.

### BACKGROUND

Automated machines, frequently called vending machines, are often used to sell products to users without another human's assistance. Vending machines are typically placed by merchants in locations where it is believed that there is a demand for a product but where it is uneconomical and/or impractical to provide another human's assistance to sell the product to the user.

A vending machine will generally contain an inventory of one or more products to be sold to a user. The vending machine's owner or an owner's agent typically restocks the inventory of products within the vending machine on a periodic or as needed basis.

A user typically purchases a product from a vending machine by first identifying the product sold by the vending machine that the user wishes to purchase. The user then notes the displayed price of the product and either (1) inputs the product selection to the vending machine and then submits the appropriate payment to the vending machine, or (2) submits the appropriate payment to the vending machine and then inputs the product selection to the vending machine. The vending machine then dispenses the selected product to the user.

Firewood is a product that is frequently purchased by users for a variety of uses such as for use in a fireplace, in a wood stove, and/or in a campfire. However, there are many locations where there is a demand for firewood but where it is uneconomical and/or impractical to provide a human to sell firewood. Such locations may include, but are not limited to, parks, campgrounds, beaches, and/or resorts. Additionally, there are many situations where although firewood is currently being offered for sale via another human's assistance, it would be desirable to sell the firewood through a vending machine in order to improve customer service and/or reduce costs. However, due to the relatively large size and weight of firewood, it is not practical to sell it from a prior art vending machine. Therefore, a vending machine that allows a user to purchase firewood without the assistance of another human is needed. Such firewood vending machine should present the user a single dispensing means from which the user obtains purchased firewood. Additionally, the firewood vending machine should be vandalism resistant and easy to restock with firewood.

### SUMMARY

A firewood dispenser, which may function as a firewood vending machine, is disclosed. The firewood dispenser is capable of permitting a user to purchase a desired quantity of firewood from an inventory of firewood stored within the firewood dispenser. The user may purchase firewood from the firewood dispenser by entering the desired quantity of firewood and submitting the appropriate amount of payment into the firewood dispenser. The firewood dispenser then dispenses the desired quantity of firewood to the user. The inventory of firewood contained within the firewood dispenser may be restocked by the firewood dispenser's owner or an owner's agent on a periodic and/or on an as needed basis.

These and other features and advantages of the firewood dispenser reside in the construction of parts and the combination thereof, the mode of operation and use, as will become more apparent from the following description, reference being made to the accompanying drawings that form a part of this specification wherein like reference characters designate corresponding parts in the several views. The embodiments and features thereof are described and illustrated in conjunction with systems, tools and methods which are meant to exemplify and to illustrate, not being limiting in scope.

### BRIEF DESCRIPTION OF THE DRAWINGS

FIG. 1 is a front perspective view of firewood dispenser 2.

FIG. 2 is a side perspective view of firewood dispenser 2 showing service person 36 restocking firewood 6 inventory into storage box 34 via open access door 10.

FIG. 3 is a top plan view of firewood dispenser 2 with the top of enclosure 22 removed.

FIG. 4 is a front perspective view of firewood dispenser 2 with enclosure 22 removed.

FIG. 5 is a side perspective view of firewood dispenser 2 with enclosure 22 removed.

FIG. 6 is a side perspective view of storage box 34.

FIG. 7 is a side perspective view of storage box 34.

FIG. 8 is a front perspective view of storage box 34, dispensing box 152, and dispensing drawer 4.

FIG. 9 is a front perspective view of storage box 34, dispensing box 152, and dispensing drawer 4.

FIG. 10 is a front perspective view of storage box 34, dispensing box 152, and dispensing drawer 4.

FIG. 11 is a top perspective view of storage box 34 aligned above dispensing box 152 taken along direction 11 of FIG. 10.

FIG. 12 is a front perspective view of storage box 34, dispensing box 152, and dispensing drawer 4.

FIG. 13 is a top perspective view of storage box 34 aligned above dispensing box 152 taken along direction 13 of FIG. 12.

FIG. 14 is a top perspective view of dispensing drawer 4 in its opened position.

FIG. 15 is a front perspective view of firewood dispenser 2 with enclosure 22 removed.

FIG. 16 is a back perspective view of dispensing drawer 4.

FIG. 17 is a back perspective view of dispensing drawer 4.

FIGS. 18a and 18b are a flow chart of the firewood 6 dispensing and reloading process in one embodiment of firewood dispenser 2.

FIG. 19 is front perspective view of storage box 34, dispensing box 152, and dispensing drawer 4.

Before explaining the disclosed embodiments in detail, it is to be understood that the embodiments are not limited in application to the details of the particular arrangements shown, since other embodiments are possible. Also, the terminology used herein is for the purpose of description and not of limitation.

### DETAILED DESCRIPTION OF THE DRAWINGS

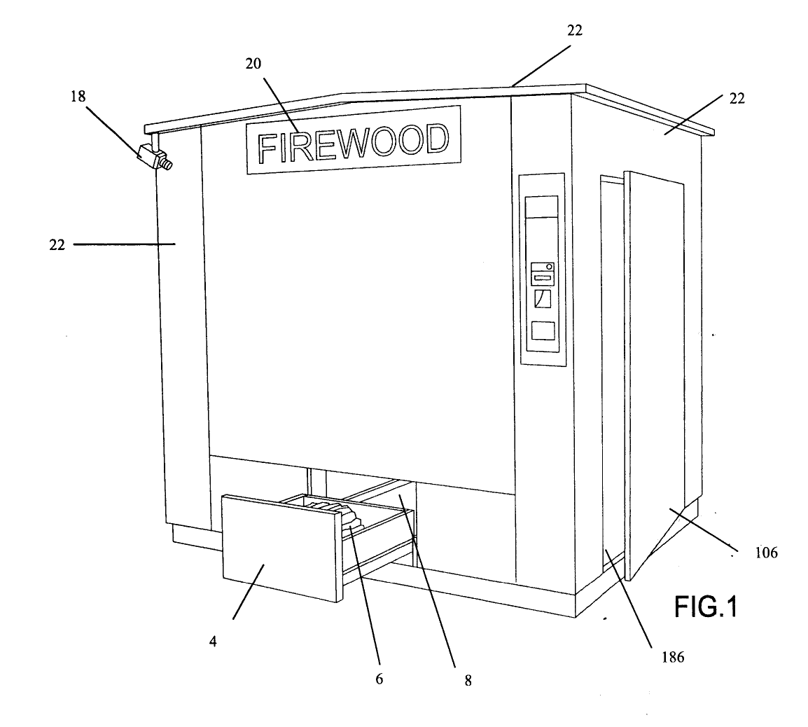

FIG. 1 is a front perspective view of firewood dispenser 2. Enclosure 22 forms the outer enclosure of firewood dispenser 2. Access door 10b provides access to the interior 186 of enclosure 22 for restocking of firewood 6 and/or servicing of firewood dispenser 2. Dispensing drawer 4 opens toward a user to enable the user to obtain firewood 6 via opening 8 in enclosure 22.

Firewood dispenser 2 may comprise label 20 to notify a prospective user that firewood 6 may be purchased from firewood dispenser 2. Firewood dispenser 2 may also comprise camera 18 to provide a video image of user transactions. The video image from camera 18 may be stored in a storage subsystem (not shown) of firewood dispenser 2 and/or may be transmitted to a remote location via a communication link (not shown) for remote storage and/or for remote real time viewing.

The following is an example of a method of operation of firewood dispenser 2, which is offered by way of example and not of limitation. It is to be understood that firewood dispenser 2 may be configured to operate in a plurality of different manners. A user who wishes to purchase firewood 6 may enter the desired quantity of firewood 6 into keypad 26. The cost of the desired quantity of firewood 6 is displayed on display 32. The user then submits to firewood dispenser 2 the amount of payment displayed on display 32. The user may submit payment to firewood dispenser 2 via currency acceptor 12, coin acceptor 16, and/or other mediums of payment (not shown) such as one or more tokens, a credit card, a debit card, and/or any other electronic card. The user may obtain change via change slot 14. If the user submitted coins and wishes to cancel the transaction, the user may request that the user's coins be returned by activating coin return request 24 and obtain returned coins via change slot 14.

Once the user submits to firewood dispenser 2 the amount of payment displayed on display 32, dispensing drawer 4 will then slide outward towards the user enabling the user to obtain an unit of firewood 6. Dispensing drawer 4 will remain open until the user removes firewood 6. After the user removes firewood 6, dispensing drawer 4 will close if opening 8 is clear. If there is an obstruction in opening 8 (e.g. the user's hand), dispensing drawer 4 will not close. In the event the user purchased more than one unit of firewood, firewood dispenser 2 will refill dispensing drawer 4 with another unit of firewood 6 after dispensing drawer 4 closes. Dispensing drawer 4 will then reopen to enable the user to obtain another unit of firewood. This process of refilling dispensing drawer 4 with firewood and reopening dispensing drawer 4 will be repeated until the total quantity firewood 6 purchased by the user is dispensed to the user.

Indicator 30 may be provided to inform the user that the user must select a smaller desired quantity of firewood 6 in the event that firewood dispenser 2 does not contain sufficient inventory of firewood 6 to supply the user's desired quantity. Indicator 28 may be provided to inform the user that the user must provide exact change in the event firewood dispenser 2 contains insufficient coins and/or currency to provide change.

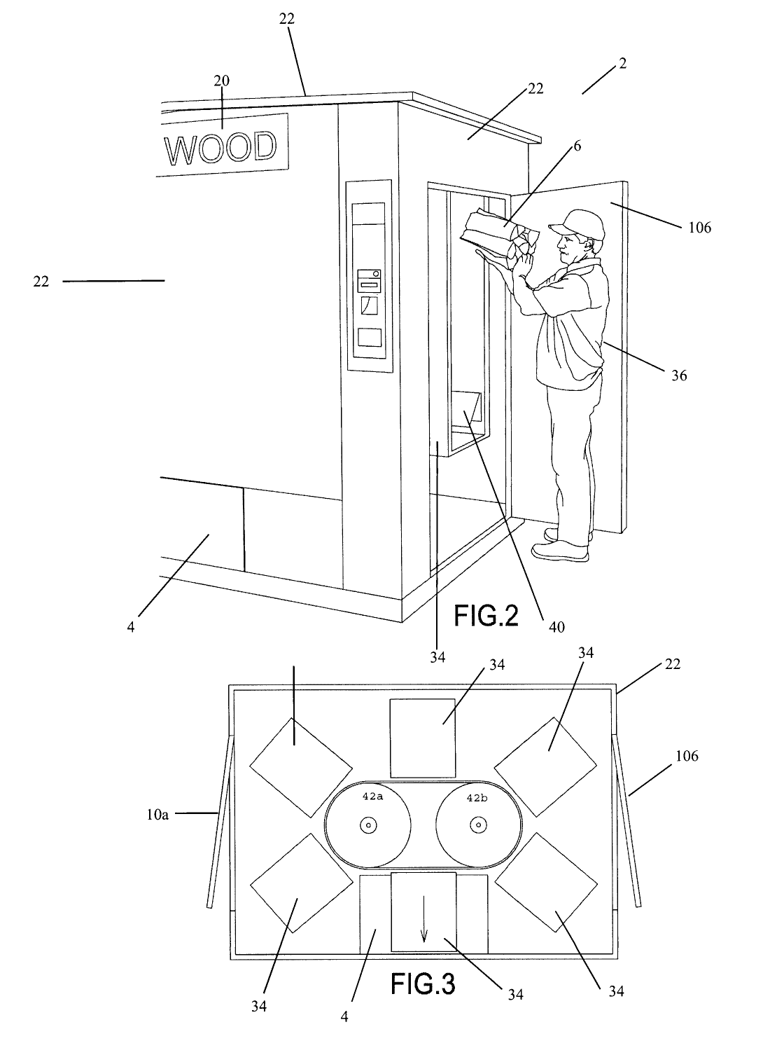

FIG. 2 is a side perspective view of firewood dispenser 2 showing service person 36 restocking firewood 6 inventory into storage box 34 via open access door 10b. Gate 40 restrains firewood 6 in storage box 34 so firewood 6 does not fall out of storage box 34 under the force of gravity. Gate 40 is opened when storage box 34 is aligned above dispensing box 152 as shown in FIG. 9. Base 38 forms the bottom of firewood dispenser 2. Also shown in FIG. 2 are enclosure 22, label 20, and dispensing drawer 4.

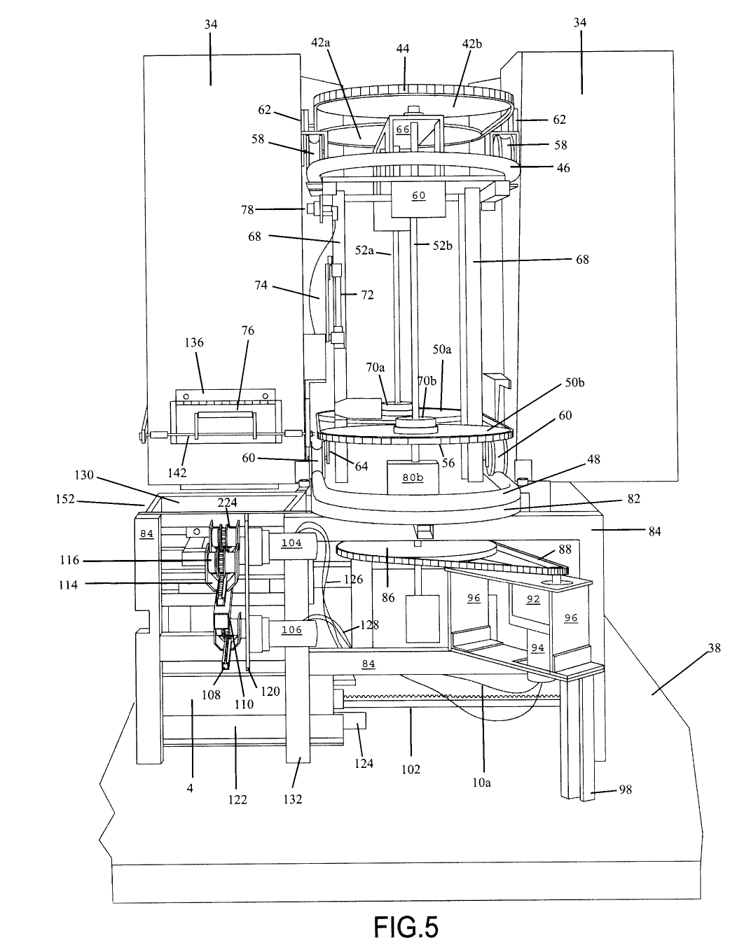

FIG. 3 is a top plan view of firewood dispenser 2 with the top of enclosure 22 removed. Firewood dispenser 2 comprises a plurality of storage boxes 34 for storing firewood 6 inventory. Storage boxes 34 are connected to upper chain 44 via upper brackets 62 as shown in FIG. 5. Upper chain 44, which is rotated by upper sprocket 42b, rotates upper sprocket 42a.

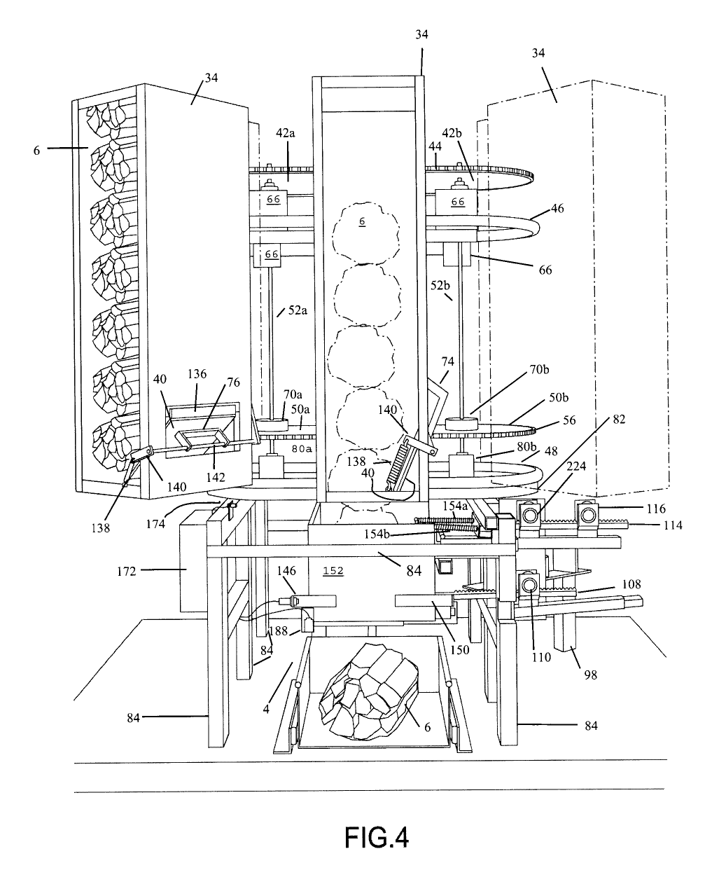

Storage boxes 34 rotate around upper track 46 (shown on FIG. 4) as well as corresponding lower track 48 (shown on FIG. 4) via upper chain 44 and lower chain 56 (shown in FIG. 4). A given storage box 34 may be aligned above dispensing box 152 (shown in FIG. 4) to allow firewood 6 stored in the given storage box 34 to be loaded into dispensing box 152. Additionally, a given storage box 34 may be rotated so it is in communication with access door 10a or 10b to allow service person 36 (shown in FIG. 2) to restock the given storage box 34 with firewood 6. Also shown in FIG. 3 is dispensing drawer 4.

FIG. 4 is a front perspective view of firewood dispenser 2 with enclosure 22 removed. Base support structure 84 provides the main support for firewood dispenser 2. Support structure 82, which supports lower track 48, is attached to the top of base support structure 84. Support structures 80a and 80b, which are connected to support structure 82, support shafts 52a and 52b respectively. Connector 70a connects lower sprocket 50a to shaft 52a, and connector 70b connects lower sprocket 50b to shaft 52b. Support structure 66, which is supported by support structure 68 (shown in FIG. 5), supports upper sprockets 42a and 42b.

Firewood dispenser 2 comprises a plurality of storage boxes 34 which are supported by lower track 48 via lower brackets 64 and lower wheels 60 (shown in FIG. 5) as well as upper track 46 via upper brackets 62 and upper wheels 58 (shown in FIG. 5). Lower chain 56 is connected to storage boxes 34 via lower brackets 64 (shown in FIG. 5), and upper chain 44 is connected to storage boxes 34 via upper brackets 62 (shown in FIG. 5). Because lower sprocket 50a is connected to lower sprocket 50b via lower chain 56, lower sprockets 50a and 50b rotate together. Similarly, because upper sprocket 42a is connected to upper sprocket 42b via upper chain 44, upper sprockets 42a and 42b rotate together. Lower sprocket 50a is connected to upper sprocket 42a via shaft 52a, and lower sprocket 50b is connected to upper sprocket 42b via shaft 52b. Because lower sprockets 50a and 50b and upper sprockets 42a and 42b are all interconnected, they all rotate together. Consequently, lower chain 56 rotates together with upper chain 44. Storage boxes 34 rotate along lower track 48 and upper track 46 via lower chain 56 and upper chain 44.

When a given storage box 34 is not aligned above dispensing box 152, gate 40 prevents firewood 6 from falling out of the given storage box 34. As will be explained in detail below, gate 40 is operated by spring 138, members 74 and 140, shaft 142, roller 76, and hinge 136.

Sensor 174 detects whether the given storage box 34 aligned above dispensing box 152 contains firewood 6 inventory. If not, firewood dispenser 2 rotates storage boxes 34 along lower track 48 and upper track 46 until a storage box 34 that contains firewood is aligned above dispensing box 152. In this manner, firewood dispenser 2 is able to dispense firewood 6 until all storage boxes 34 no longer contain firewood 6 inventory.

Transmitter/receiver 146 and reflector 150 may be used to detect if opening 8 (shown in FIG. 1) of enclosure 22 is obstructed. Transmitter/receiver 146 projects a beam of infrared light to reflector 150 which in turn reflects the beam of infrared light back to transmitter/receiver 146. If the beam of infrared light is broken by an obstruction (e.g. a user's hand), the transmitter/receiver will detect an absence of the reflected beam of infrared light from reflector 150 and will thereby detect an obstruction. Firewood dispenser 2 may be configured such that dispensing drawer 4 will not close if transmitter/receiver 146 detects an obstruction in opening 8 of enclosure 22. Sensor 188 may be used to detect if firewood dispenser 2 is jammed, as will be described in more detail below.

Control box 172 may be used to house the electrical controls of firewood dispenser 2. As will be discussed in further detail below, springs 154a and 154b are used to apply force to stops which prevent firewood 6 from falling out of storage box 34. The stops connected to springs 154a and 154b are moved horizontally via track 114, sprocket 116, and optional sprocket 224. Sprocket 116 and optional sprocket 224 are driven by electric motor 104 (shown in FIG. 5).

As will be discussed in further detail below, door 162 (as shown in FIG. 10) in dispensing box 152 controls the release of firewood 6 from dispensing box 152 into dispensing drawer 4. Door 162, which moves horizontally, is opened and closed via track 108 and sprocket 110. Sprocket 110 is driven by electric motor 106 (shown in FIG. 5). Leg 98 helps support electric motor 94 as shown in FIG. 5.

FIG. 5 is a side perspective view of firewood dispenser 2 with enclosure 22 removed. Base support structure 84, which rests on base 38, provides the main support for firewood dispenser 2. Support structure 82, which supports lower track 48, is attached to the top of base support structure 84. Support structure 80b, which is connected to support structure 82, supports shaft 52b. Connector 70a connects lower sprocket 50a to shaft 52a, and connector 70b connects lower sprocket 50b to shaft 52b. Support structure 68, which is supported by base support structure 84, supports support structure 66. Support structure 66 supports upper sprockets 42a and 42b.

Storage boxes 34 are supported by lower track 48 via lower brackets 64 and lower wheels 60 as well as upper track 46 via upper brackets 62 and upper wheels 58. Lower chain 56 is connected to storage boxes 34 via lower brackets 64, and upper chain 44 is connected to storage boxes 34 via upper brackets 62. Storage boxes 34 rotate along lower track 48 and upper track 46 via lower chain 56 and upper chain 44.

Main sprocket 86 is connected to shaft 52b. Thus, main sprocket 86 indirectly rotates lower sprockets 50a and 50b, upper sprockets 42a and 42b, as well as lower chain 56 and upper chain 44. Electric motor 94 rotates main sprocket 86 via transmission 92 and main drive chain 88. Electric motor 94 is supported by support structure 96 which is partially supported by leg 98. Electric motor 94 is powered and controlled by electrical signals delivered to electric motor 94 via cables 100.

Sensor 78 detects when a given storage box 34 is aligned above dispensing box 152. As will be discussed in more detail below, when a given storage box 34 is aligned above dispensing box 152, a door within the given storage box 34 is opened, and firewood 6 falls from the given storage box 34 into cavity 130 of dispensing box 152. The door within a given storage box storage box 34 aligned above dispensing box 152 is controlled by elements including stack actuator 72, member 74, shaft 142, roller 76, and hinge 136.

Also shown in FIG. 5 are electric motor 104, its associated cables 126, sprocket 116, optional sprocket 224, and track 114. As will be discussed in more detail below, these elements cooperate with springs and stops to prevent additional firewood 6 from falling into dispensing drawer 4 when dispensing box 152 is dispensing firewood 6 into dispensing drawer 4.

Door 162 (shown in FIGS. 10 and 12) within dispensing box 152 operates to control the dispensing of firewood 6 from dispensing box 152 to dispensing drawer 4. Door 162 is operated by electric motor 106 via sprocket 110 and track 108. Electric motor 106 is controlled and operated by electrical signals carried by cables 128. Leg 132 helps support electric motor 104, and support structure 120 helps support electric motor 106.

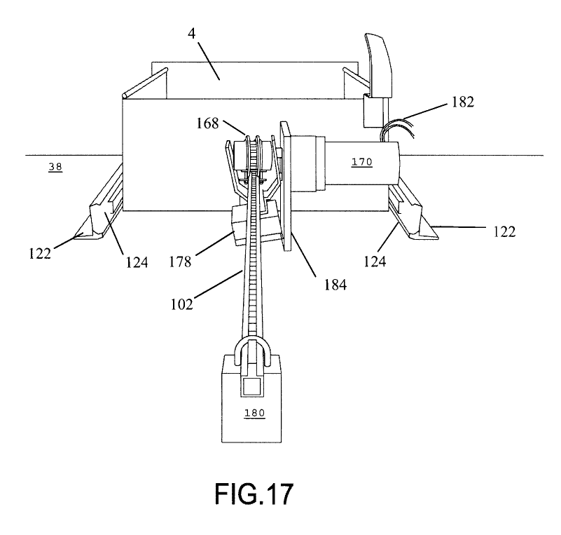

Dispensing drawer 4, which is shown in its closed position, slides outward along track 122 via runners 124 to dispense firewood 6 to a user. Dispensing drawer 4 is moved horizontally by track 102 which is driven by sprocket 168 (shown in FIGS. 16 and 17) and electric motor 170 (shown in FIGS. 16 and 17).

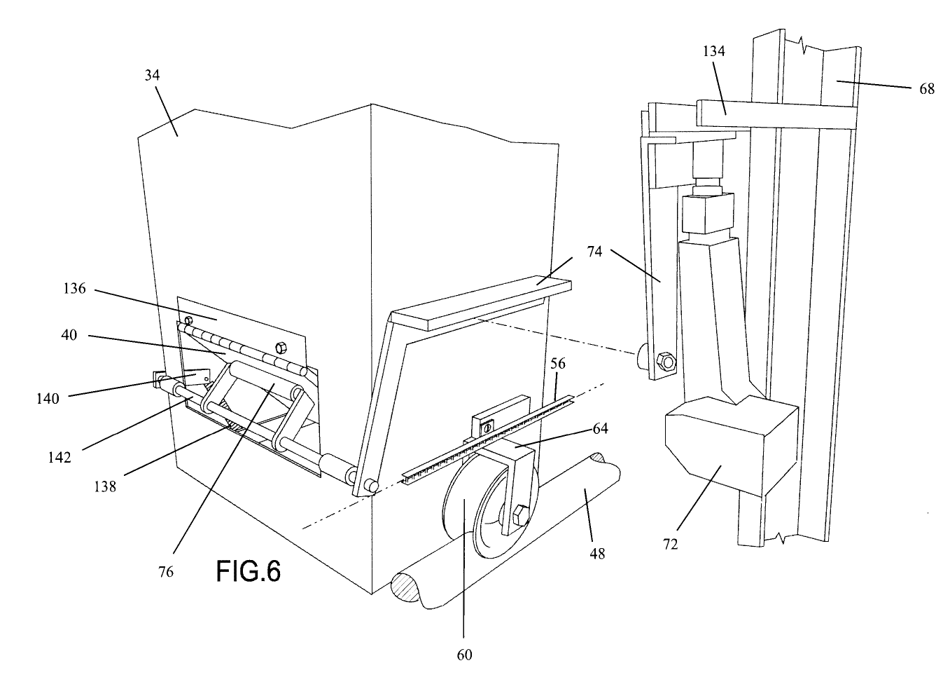

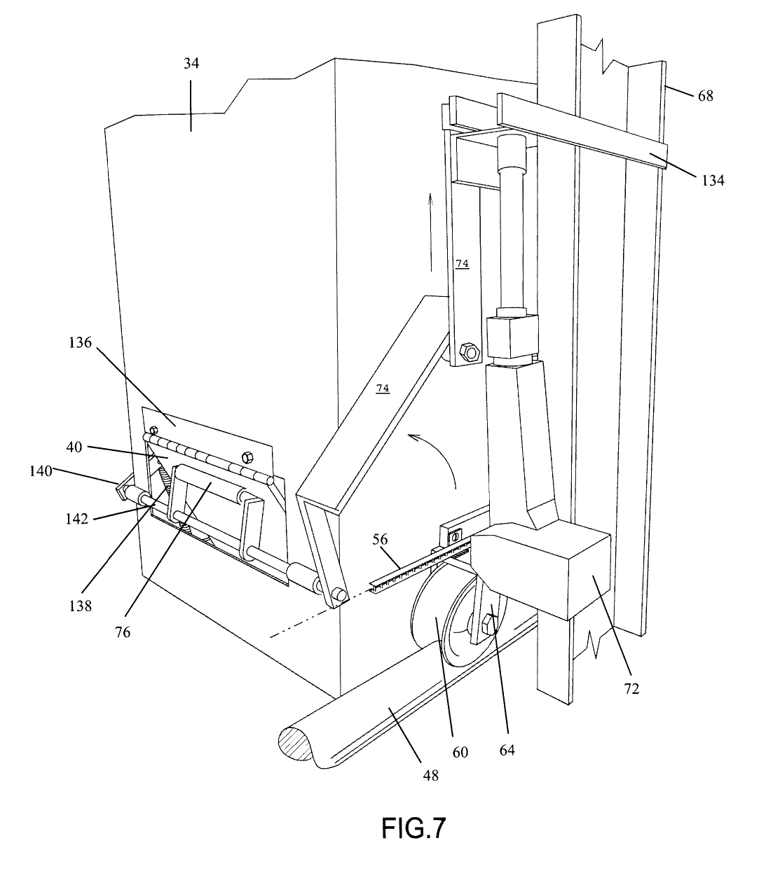

FIGS. 6 and 7 are side perspective views of storage box 34. Gate 40, which holds firewood 6 in storage box 34 when storage box 34 is not aligned above dispensing box 152, is attached to storage box 34 via hinge 136. One end of spring 138 is connected to storage box 34 while the other end of spring 138 is connected to member 140. Shaft 142 is connected to roller 76, and shaft 142 is also connected to member 74. Member 74 is connected to guide 134 which slides up and down support structure 68 in response to movement of stack actuator 72.

Spring 138 operates to pull roller 76 into storage box 34 and under gate 40 via member 140 and shaft 142. Thus, except when spring 138's force is countered by stack actuator 72, spring 138 causes gate 40 to remain closed as shown in FIG. 6.

When sensor 78 (shown in FIG. 5) detects that a given storage box 34 is aligned above dispensing box 152, stack actuator 72 is extended. This causes member 74 to rotate shaft 142 against the force of spring 138 such that roller 76 is no longer positioned inside storage box 34 and under gate 40. This operating condition is shown in FIG. 7. Because roller 76 is no longer supporting gate 40, gate 40 falls open under the force of gravity and releases firewood 6 into dispensing box 152.

Also shown in FIGS. 6 and 7 is lower wheel 60 which is attached to storage box 34 via lower bracket 64. Lower wheel 60 rides along lower track 48. Lower chain 56 is attached to lower bracket 64.

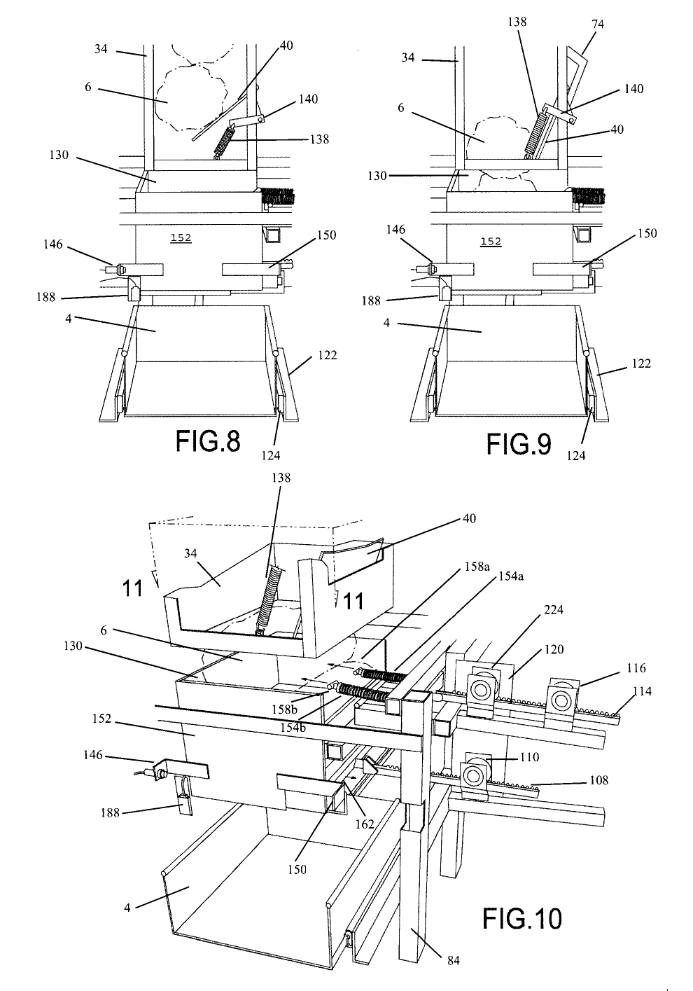

FIGS. 8 and 9 are front perspective views of storage box 34, dispensing box 152, and dispensing drawer 4. The front of storage box 34 is cutaway in FIGS. 8 and 9. FIG. 8 shows storage box 34 aligned above dispensing box 152 before firewood 6 is dispensed into cavity 130 of dispensing box 152. Gate 40 holds firewood 6 in storage box 34.

FIG. 9 shows storage box 34 aligned above dispensing box 152 after firewood 6 is dispensed into cavity 130 of dispensing box 152. Gate 40 has opened and no longer prevents firewood 6 from falling out of storage box 34. Also shown in FIGS. 8 and 9 are transceiver/receiver 146, reflector 150, sensor 188, spring 138, members 74 and 140, track 122, and runner 124.

FIGS. 10 and 12 are front perspective views of storage box 34, dispensing box 152, and dispensing drawer 4. In FIG. 10, storage box 34 is aligned above dispensing box 152, and gate 40 is opened allowing firewood 6 to enter cavity 130 of dispensing box 152. However, in FIG. 10 firewood dispenser 2 is not dispensing firewood 6 to a user. Therefore, door 162 of dispensing box 152 is not open.

Conversely, in FIG. 12, firewood dispenser 2 is dispensing firewood 6 to a user. Consequently, door 162 of dispensing box 152 is open allowing firewood 6 to fall from dispensing box 152 into dispensing drawer 4. Dispensing drawer 4 will subsequently be opened to allow the user to remove firewood 6 from dispensing drawer 4.

Stops 158a and 158b may be used to prevent more than one unit of firewood 6 from dropping from dispensing box 152 into dispensing drawer 4 when door 162 is open. Stops 158a and 158b are driven into firewood 6 in dispensing box 152 by electric motor 104 (shown in FIG. 5) via sprocket 116, optional sprocket 224, track 114, and springs 154a and 154b. Springs 154a and 154b allow stops 158a and 158b to accommodate firewood 6 of varying sizes. FIG. 12 shows stops 158a and 158b driven into firewood 6 when door 162 is open. Conversely, FIG. 10 shows stops 158a and 158b retracted away from firewood 6 when door 162 is closed.

Door 162 in the bottom of dispensing box 162 is opened and closed by electric motor 106 (shown in FIG. 5) via sprocket 110 and track 108. FIG. 10 shows door 162 in it its closed position while FIG. 12 shows door 162 in its open position. Also shown in FIGS. 10 and 12 are base support structure 84, spring 138, transmitter/receiver 146, reflector 150, sensor 188, support structure 120, track 122, and runner 124.

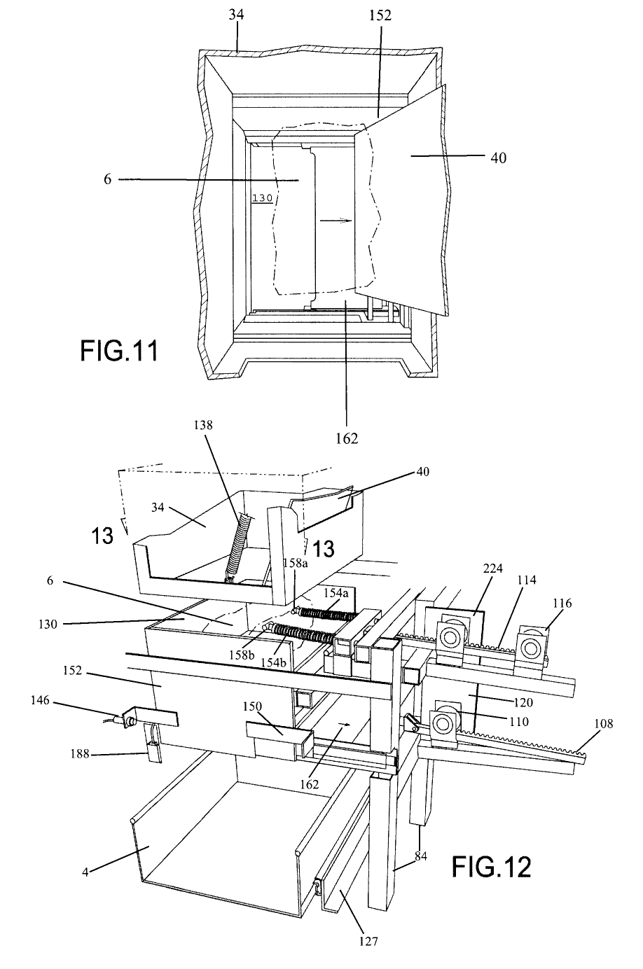

FIG. 11 is a top perspective view of storage box 34 aligned above dispensing box 152 taken along direction 11 of FIG. 10. Gate 40 of storage box 34 is open allowing firewood 6 to fall into cavity 130 of dispensing box 152. Although door 162 is shown in its closed position in FIG. 10, door 162 is shown in a partially closed position in FIG. 11.

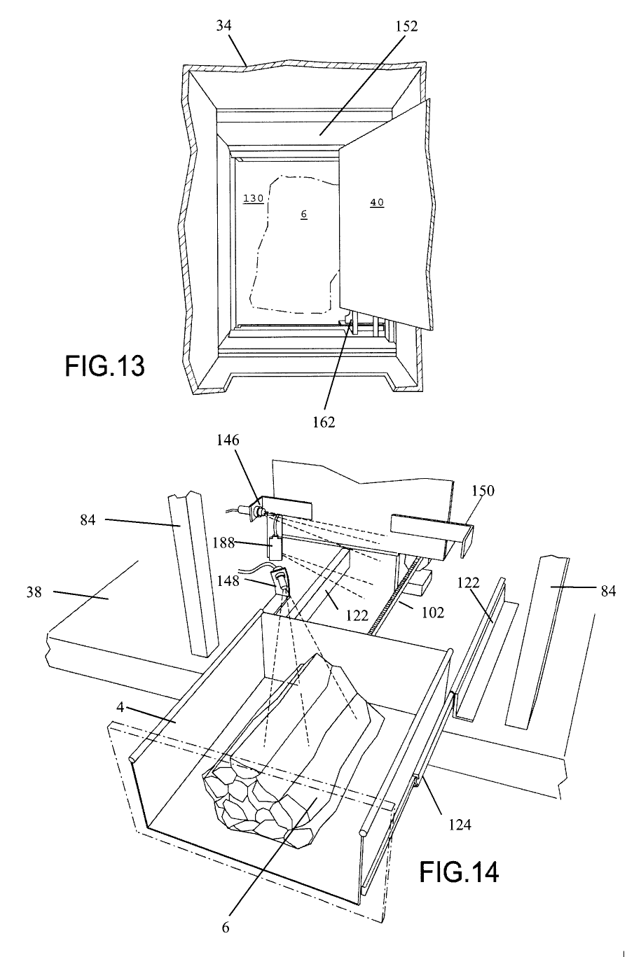

FIG. 13 is a top perspective view of storage box 34 aligned above dispensing box 152 taken along direction 13 of FIG. 12. Gate 40 of storage box 34 is open allowing firewood 6 to fall into cavity 130 of dispensing box 152. Door 162 is shown in its completely open position.

FIG. 14 is a top perspective view of dispensing drawer 4 in its open position. Dispensing drawer 4 has been pushed open by track 102 so that a user can remove firewood 6 from dispensing drawer 4. Sensor 148 detects when the user has removed firewood 6 by detecting when firewood 6 is not present in dispensing drawer 4. Sensor 188 may be used to detect if firewood dispenser 2 is jammed by detecting the presence of excess firewood 6. Also shown in FIG. 14 are base 38, base support structure 84, track 122, runner 124, transmitter/receiver 146, and reflector 150.

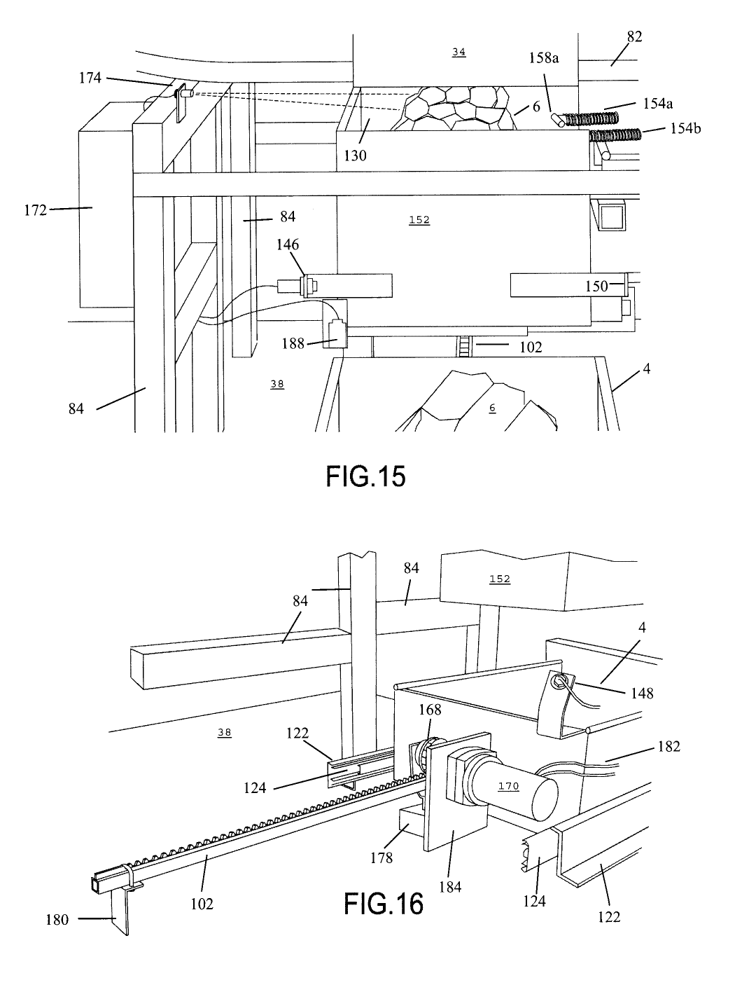

FIG. 15 is a front perspective view of firewood dispenser 2 with enclosure 22 removed. Dispensing drawer 4 contains firewood 6 for removal by a user once dispensing drawer 4 is opened. Dispensing box 152 houses additional firewood 6 in cavity 130 for dispensing. Also shown in FIG. 15 are base 38, base support structure 84, storage box 34, track 102, transmitter/receiver 146, control box 172, sensors 174 and 188, reflector 150, stop 158a, springs 154a and 154b, and support structure 82.

FIG. 16 is a back perspective view of dispensing drawer 4. Electric motor 170 drives dispensing drawer 4 horizontally along track 102 via sprocket 168. Electric motor 170 is powered and controlled via electrical signals supplied by cables 182. Electric motor 170 is supported by support structure 184.

Sensor 178 detects when dispensing drawer 4 is at either end of track 102. When dispensing drawer 4 is fully opened, actuator 180 is essentially touching sensor 178 and depresses a first switch on sensor 178. Similarly, when dispensing drawer 4 is completely closed (as shown in FIG. 16), dispenser drawer 4 is essentially touching sensor 178 and depresses a second switch on sensor 178. Also shown in FIG. 16 are tracks 122, runners 124, base 38, base support structure 84, sensor 148, and dispensing box 152.

FIG. 17 is a back perspective view of dispensing drawer 4. Shown in FIG. 17 are dispensing drawer 4, electric motor 170, sprocket 168, track 102, sensor 178, actuator 180, tracks 122, runners 124, cables 182, base 38, and support structure 184.

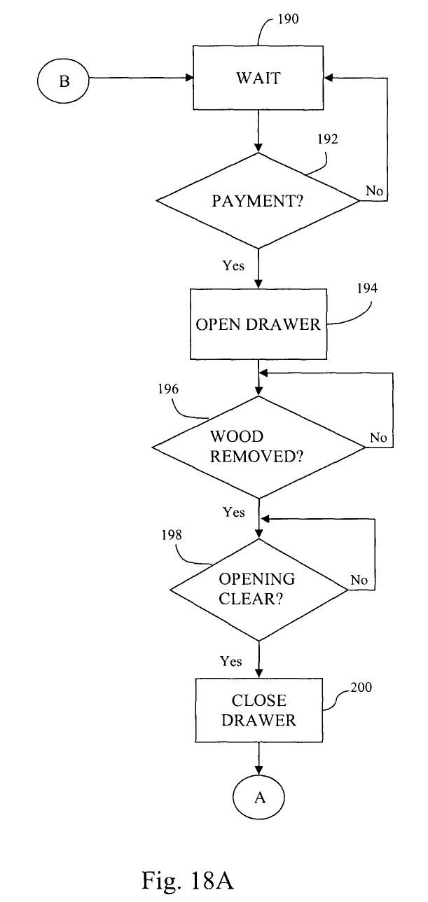

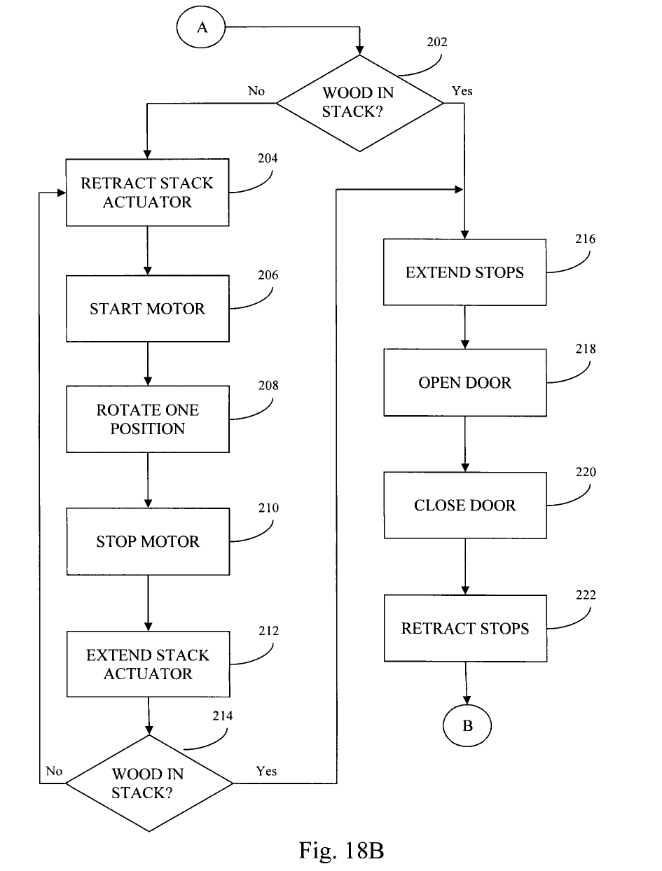

FIGS. 18a and 18b are a flow chart of the firewood 6 dispensing and reloading process in one embodiment of firewood dispenser 2. The process of FIGS. 18a and 18b is offered by way of example and not of limitation. It is to be understood that firewood dispenser 2 may be configured to operate in a plurality of different manners.

Firewood dispenser 2 waits for a user to insert payment in state 190. If a user inserts payment, decision 192 tests if sufficient payment was submitted. If no, operation returns to state 190. If yes, operation continues to state 194. In state 194, dispensing drawer 4 is opened so that the user may remove firewood 6 from dispensing drawer 4. Operation then continues to decision 196 where sensor 148 determines if the user has removed firewood 6 from dispensing drawer 4. If no, operation remains in decision 196. Otherwise, operation continues to decision 198. Decision 198 checks via transmitter/receiver 146 and reflector 150 if opening 8 of enclosure 22 is clear. If no, operation remains at decision 198. If yes, operation continues to state 200. In state 200, dispensing drawer 4 is closed.

Operation next proceeds to decision 202 which tests via sensor 174 if firewood 6 is contained in the storage box 34 aligned above dispensing box 152. If no, operation continues to state 204 which retracts stack actuator 72. Gate 40 in the storage box 34 aligned above dispensing box 152 thereby closes. Operation proceeds to state 206 where electric motor 94 is started. Storage boxes 34 are rotated one position in state 208. Electric motor 94 is turned off in state 210. Stack actuator 72 is extended in state 212 which causes gate 40 of the storage box 34 aligned above dispensing box 152 to thereby open. Operation then proceeds to decision 214 which tests via sensor 174 if firewood 6 is contained in the storage box 34 aligned above dispensing box 152. If no, operation returns to state 204.

If the result of decisions 202 or 214 is yes, operation proceeds to state 216 where stops 158a and 158b are extended to prevent additional firewood 6 from falling into dispensing box 152. In state 218, door 162 is opened allowing firewood 6 contained in dispensing box 152 to fall into dispensing drawer 4. Door 162 is then closed in state 220. Stops 158a and 158b are retracted in state 222. Operation then returns to state 190 where firewood dispenser 2 waits for a user to insert payment.

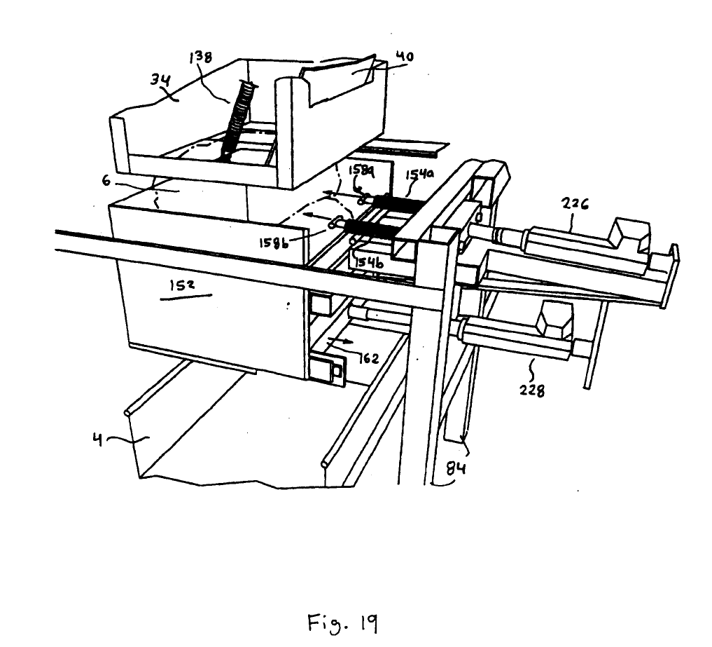

FIG. 19 is a front perspective view of storage box 34, dispensing box 152, and dispensing drawer 4. FIG. 19 shows an alternative embodiment of firewood dispenser 2 where track 114, sprocket 116, optional sprocket 224, and electric motor 104 have been replaced by upper actuator 226. Upper actuator 226 operates by extending and retracting a piston in response to an electric signal. Upper actuator 226 moves stops 158a and 158b as well as springs 154a and 154b horizontally into and out of dispensing box 152.

Additionally, track 108, sprocket 110, and electric motor 106 have been replaced by lower actuator 228 in FIG. 9. Lower actuator 228 operates by extending and retracting a piston in response to an electric signal. Lower actuator 228 opens and closes door 162 in dispensing box 152. Also shown in FIG. 19 are storage box 34, spring 138, gate 40, firewood 6, dispensing drawer 4, and base support structure 84.

While a number of exemplifying features and embodiments have been discussed above, those of skill in the art will recognize certain modifications, permutations, additions and subcombinations thereof. No limitation with respect to the specific embodiments disclosed herein is intended or should be inferred.

1. A firewood dispensing apparatus comprising:
a dispensing box; and
a plurality of wood storage boxes selectively associable with the dispensing box so that firewood may be gravity fed from a select wood storage box to the dispensing box.

2. The firewood dispensing apparatus of claim 1 further comprising a
track around which the plurality of wood storage boxes may rotate such that only a single select wood storage box may be operatively positioned over the dispensing box at one time.

3. The firewood dispensing apparatus of claim 2 further comprising an upper and a lower track around which the plurality of wood storage boxes may rotate such that only a single select wood storage box may be operatively positioned over the dispensing box at one time.

4. The firewood dispensing apparatus of claim 3 wherein the upper and lower track define a substantially horizontal elliptical path around which the plurality of wood storage boxes may rotate such that only a single select wood storage box may be operatively positioned over the dispensing box at one time.

5. The firewood dispensing apparatus of claim 1 further comprising a gate operatively associated with each wood storage box and configured to prevent firewood contained within the wood storage box form being dispensed if the wood storage box is not aligned with the dispensing box.

6. The firewood dispensing apparatus of claim 1 further comprising a sensor configured to sense whether a select wood storage box contains firewood.

7. The firewood dispensing apparatus of claim 1 further comprising at least one stop operatively associated with each wood storage box to releasably secure firewood placed therein.

8. The firewood dispensing apparatus of claim 1 further comprising a dispensing drawer operatively associated with the dispensing box; and
a door operatively disposed between the dispensing box and the dispensing drawer.

9. The firewood dispensing apparatus of claim 1 further comprising a control system configured to actuate the firewood dispensing apparatus upon the deposit of a select fee.

10. The firewood dispensing apparatus of claim 1 further comprising:
a housing;
an access door in the housing providing access to a select wood storage box for loading firewood into the select wood storage box.

11. A method of dispensing firewood comprising:
providing a firewood dispensing apparatus including a plurality of wood storage boxes operatively associated with a dispensing box so that firewood may be gravity fed from a select wood storage box to the dispensing box;
rotating the select wood storage box to a position over the dispensing box; and
dispensing firewood from the select wood storage box to the dispensing box.

12. The method of dispensing firewood of claim 11 further comprising:
detecting that the select wood storage box positioned over the dispensing box contains an insufficient amount of firewood;
rotating a second select wood storage box to a position over the dispensing box; and
dispensing firewood from the second select wood storage box to the dispensing box.

13. The method of dispensing firewood of claim 12 wherein the plurality of wood storage boxes are rotated horizontally around a substantially elliptical track.

14. The method of dispensing firewood of claim 11 wherein firewood is automatically dispensed in exchange for the payment of a fee.
